(19) United States
(12) Patent Application Publication
(10) Pub. No.: US 2013/0317952 A1
(43) Pub. Date: Nov. 28, 2013

(54) SYSTEM AND METHOD FOR CREATING AND PROVIDING APPLICATION COLLECTIONS

(71) Applicant: OpenPeak Inc., Boca Raton, FL (US)

(72) Inventors: Benjamin J. Tomassetti, San Francisco, CA (US); David Hugh Hoffer, Oakland, CA (US); Holly S. Keenan, San Mateo, CA (US)

(73) Assignee: OpenPeak Inc., Boca Raton, FL (US)

(21) Appl. No.: 13/901,877

(22) Filed: May 24, 2013

Related U.S. Application Data
(60) Provisional application No. 61/651,236, filed on May 24, 2012.

(51) Int. Cl. G06Q 30/06

(52) U.S. Cl. CPC G06Q 30/0641
USPC 705/27.1

(57) ABSTRACT

A method for creating an application collection is described herein. The method can include the steps of providing a plurality of applications for potential selection as part of an application collection based on a defined category and receiving selections that designate one or more of the provided applications for inclusion in the application collection. The method can also include the steps of tagging the applications based on the received selections and grouping the tagged applications together to form the application collection. The application collection can then be published in an application store as an offering based on the defined category.

This patent application claims priority to U.S. Patent Application No. 61/651,236, filed on May 24, 2012, which is incorporated herein by reference in its entirety.

### FIELD OF TECHNOLOGY

The present subject matter relates to systems and methods for increasing the functionality of an application store.

### BACKGROUND

The use of applications, commonly referred to as “apps,” has become prevalent over the past few years. To meet this demand, several entities have developed services to enable users of mobile devices to download applications to such devices. For example, Apple, Inc. of Cupertino, Calif. offers an interface to permit applications to be uploaded from application developers and for users to search, select and possibly purchase applications for download to Apple devices. As part of this process, a user can create an account through an Apple storefront, and the user can make purchases through this online store, each of which can be eventually downloaded to the user's mobile device. There is a need in this industry to increase the utility of these online stores.

### SUMMARY

A method for creating an application collection is described herein. The method can include the steps of providing a plurality of applications for potential selection as part of an application collection based on a defined category and receiving selections that designate one or more of the provided applications for inclusion in the application collection. The method can also include the steps of tagging the applications based on the received selections and grouping the tagged applications together to form the application collection. The application collection can be published in an application store as an offering based on the defined category.

In one arrangement, the method can also include the step of receiving additional selections that designate at least some of the applications selected for inclusion in the defined category as mandatory or optional for inclusion in the application collection to be published. The method can also include the step of enabling an individual application to be added to the published application collection.

As another option, the fees that are associated with applications that are part of the grouped application collection can be determined, and a reduced cumulative amount for the determined fees can be provided as part of a discount for the application collection to be published. As an example, the defined category can be a movie theme, a restaurant theme, a hotel theme, a sports team theme, a geographical location theme, a manufacturer or retailer theme, an activity theme, an occupation theme, a historical theme, a fashion theme, an academic subject theme or a music theme. In addition, grouping the tagged applications can include staging the tagged applications in an application collection holding area that is separate from the area that provides the plurality of applications for potential selection as part of the application collection.

Another method for creating an application collection is described herein. The method can include the step of presenting a plurality of applications for potential selection as part of an application collection based on a defined category. The applications can be presented based on one or more search terms or a selection of a predefined macro organizer. The method can further include the steps of receiving selections that designate one or more of the presented applications for inclusion in the application collection, tagging the applications based on the received selections and staging the tagged applications in an application collection holding area to form the application collection. The application collection can be published in an application store as an offering based on the defined category.

A system for creating an application collection is also described herein. The system can include a display unit that is configured to display a plurality of applications for potential selection as part of an application collection based on a defined category. The system can also include a processing unit that can be communicatively coupled to the display unit. The processing unit can be configured to receive selections that designate one or more of the provided applications for inclusion in the application collection, tag the applications based on the received selections and group the tagged applications together to form the application collection. The processing unit can be further configured to direct the publication of the application collection in an application store as an offering based on the defined category.

The processing unit can be further configured to receive additional selections that designate at least some of the applications selected for inclusion in the defined category as mandatory or optional for inclusion in the application collection to be published. Moreover, the processing unit can be configured to enable an individual application to be added to the published application collection.

In another embodiment, the processing unit can be configured to determine fees that are associated with applications that are part of the grouped application collection and determine a reduced cumulative amount for the determined fees as part of a discount for the application collection to be published. In yet another embodiment, the processing unit can group the tagged applications by staging the tagged applications in an application collection holding area.

Further features and advantage, as well as the structure and operation of various embodiments, are described in detail below with reference to the accompanying drawings. It is noted that this description is not limited to the specific embodiments presented herein. Such embodiments are provided for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles of the invention and to enable a person skilled in the relevant art(s) to make and use the invention.

FIG. 1 illustrates an example of a system for creating an application collection.

FIG. 2 illustrates an exemplary method for creating an application collection.

FIG. 3 illustrates an example of an interface for presenting applications.

FIG. 4 illustrates an example of the interface of FIG. 3 with several applications selected for creating an application collection.

FIG. 5 illustrates an example of an interface for designating applications as mandatory or optional for an application collection.

FIG. 6 illustrates an example of a presentation of an application store.

FIG. 7 illustrates an example of a selected application collection.

FIG. 8 illustrates an example of an interface for selecting optional applications for an application collection.

FIG. 9 illustrates an example of an interface for adding an application to an application collection.

Applicants expressly disclaim any rights to any third-party trademarks or copyrighted images included in the figures. Such marks and images have been included for illustrative purposes only and constitute the sole property of their respective owners.

The features and advantages of the embodiments herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected such that communication signals are able to be exchanged between the components on a unidirectional or bidirectional (or multi-directional) manner, either wirelessly, through a wired connection or a combination of both. A “computing device” is defined as a component that is configured to perform some process or function for a user and includes both mobile and non-mobile devices. An “application” is defined as a program or programs that provide(s) an interface to enable a user to operate a computing device in accordance with one or more particular tasks. The term “operating environment” is defined as a particular setting that is associated with an electronic device and is used to control multiple operations and configurations of the electronic device.

The term “application store” is defined as an electronic platform that offers content, including applications, for delivery to a computing device. An “application collection” is defined as a collection of applications that are included in the collection based on a defined category. A “defined category” is defined as a grouping or classification in which the elements that make up the grouping or classification share a common theme or some other common characteristic or the subject matter of the grouping or classification is related to a common theme or some other common characteristic.

A “network interface” is defined as a component or group of components that at least receive(s) signals from a first device and transfers those signals to a second device in a form that is compatible with the second device. A “processing unit” is defined as one or more components that execute(s) sets of instructions. The term “storage unit” is defined as one or more components that are configured to store data, either temporarily or persistently. A “display unit” is defined as a component or a group of components that are configured to at least display elements in a form that is perceivable by a human.

As noted earlier, there is a need to increase the utility of application stores. To do so, a method for creating an application collection is described herein. The method can include the steps of providing a plurality of applications for potential selection as part of an application collection based on a predefined category and receiving selections that designate one or more of the provided applications for inclusion in the application collection. The applications may be tagged based on the received selections, and the tagged applications can be grouped together to form the application collection. In addition, the application collection can be published in an application store as an offering based on the predefined category.

As such, a user has the ability to create application collections in which the applications in the collection share a common theme or category or some other characteristic. An application collection can provide multiple avenues for a consumer to experience a favorite theme or subject, and the collections can take advantage of economies of scale to offer competitive pricing. Moreover, application developers and the entities operating application stores can see increased revenues as a result of the greater number of applications reaching consumers.

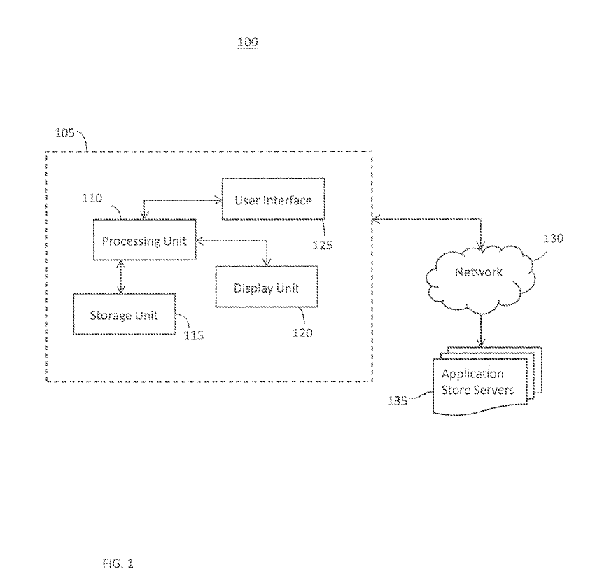

Referring to FIG. 1, an example of a system 100 for creating an application collection is shown. In one arrangement, the system 100 can include an application collection computer 105, which can be in the form or a desktop computer, a laptop computer, a smartphone or any other suitable computing device. The computer 105 may include a processing unit 110, a storage unit 115, a display unit 120 and a user interface 125. The processing unit 110 can be communicatively coupled to and manage the operation of each of the storage unit 115, the display unit 120 and the user interface 125. In addition, the user interface 125 can be any suitable interface to allow a user to enter information or data into the computer 105. Examples of this process will be presented below. The display unit 120 may also be configured to enable users to enter information or data into the computer 105, such as through suitable touch screen designs.

The application collection computer 105 can be communicatively coupled to one or more application store servers 135 via a network 130. The network 130 can be any suitable combination of interrelated elements that are capable of supporting or facilitating the transmission of communications signals, including both wired or wireless signals. The application store servers 135 can host, for example, an application store that can offer applications and other content for download to any suitable computing device.

In summary, a user of the application collection computer 105 can access an application store hosted on the application store servers 135 and can create application collections for publishing at the application store. As a result, these collections can be downloaded to any appropriate device that has access to the application store. Exemplary processes and interfaces will now be presented to describe how this procedure can be carried out.

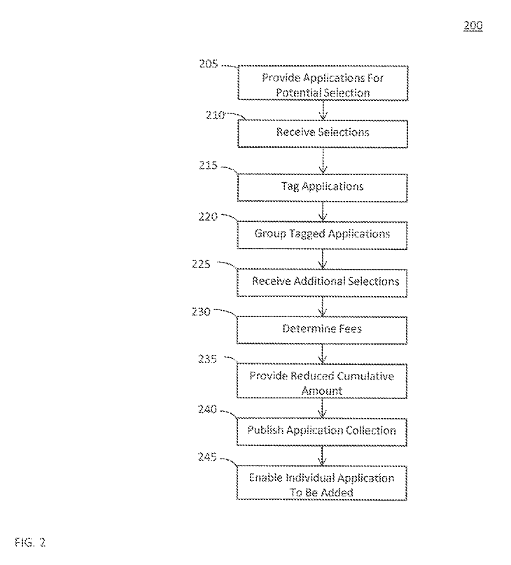

Referring to FIG. 2, a method 200 for creating an application collection is shown. The method 200 may refer back to FIG. 1, although it is understood that the method 200 may be practiced in any other suitable system or configuration. At step 205, a plurality of applications can be provided for potential selection as part of an application collection based on a defined category. At step 210, selections can be received that designate one or more of the provided applications for inclusion in the defined category, and the applications can be tagged based on the received selections, as shown at step 215. At step 220, the tagged applications can be grouped together to form the application collection. At step 225, additional selections can be received that designate at least some of the applications selected for inclusion in the application collection as mandatory or optional for inclusion in the application collected to be published.

At step 230, fees that are associated with applications that are part of the grouped application collection can be determined, and at step 235, a reduced cumulative amount for the determined fees can be provided as part of a discount for the application collection to be published. Moreover, the application collection can be published in an application store as an offering based on the defined category, as shown at step 240. In another arrangement, an individual application can be added to the published application collection, as shown at step 245.

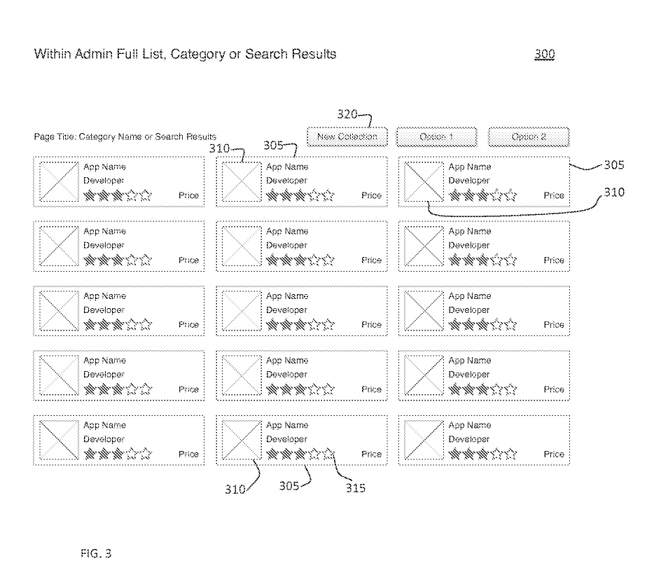

For example, referring to FIG. 3, an exemplary user interface 300 is shown in which multiple icons 305 that represent applications 310 are presented. Each of these applications 310 has the potential to be selected as part of an application collection. To realize these applications 310, a user may provide one or more search terms or may select a predefined macro organizer, either of which may be related to a defined category. For example, the user may wish to create an application collection with a theme related to a particular popular movie. The user can provide search terms that are related to this movie or can select a predefined macro organizer that is related to the subject matter, such as an organizer that is entitled with the term “movies.” In one arrangement, the predefined macro organizer, when selected, may provide additional choices, as in a drop-down or pop-up menu. For example, the movie organizer described above could provide a drop-down menu that listed several genres of movies. In either arrangement, based on the provided search terms or the predefined macro organizer selection, multiple relevant applications 310 may be presented to the user. As part of this presentation, the developer who created the application 310 and the fee (if any) associated with installing the application 310 may be presented to the user. As an option, a feedback rating 315 may be provided, which can be based on feedback received from other users.

There are numerous defined categories that may serve as the basis for the application collection 330. As described above, the defined category may be a movie theme in which a user selects applications 310 based on a particular movie or movie franchise. Other examples include a restaurant theme, a hotel theme, a sports team theme, a geographical location theme, a manufacturer or retailer theme, an activity theme, an occupation theme, a historical theme, a fashion theme, an academic subject theme or a music theme. In either case, a user can create an application collection 330 that includes applications 310 that are in some way associated with or related to a subject that interests the user. It is understood that the description herein is in no way limited to these particular exemplary defined categories, as virtually any subject, topic, theme or matter can be a defined category.

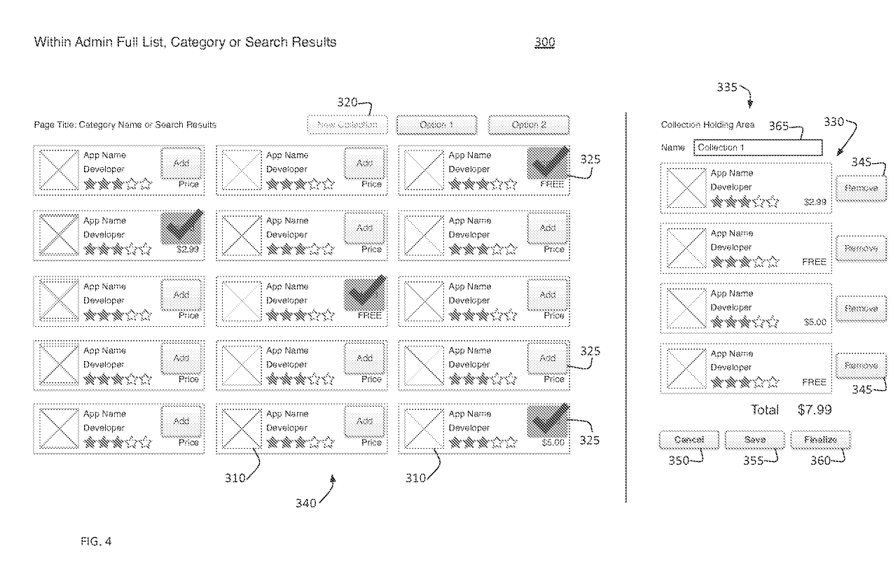

The user interface 300 may also include a new collection selection 320, which can be activated to enable the user to generate an application collection. As an example, when the new collection selection 320 is activated, a user may be given the opportunity to select any suitable number of the applications 310 presented in the user interface 300. For example, referring to FIG. 4, the user interface 300 is shown after the new collection selection 320 has been activated, and as can be seen, an addition feature 325 can be presented for each of the applications 310. The addition feature 325 can permit the user to select one or more applications 310 to form an application collection 330. In one embodiment, when a particular application 310 is selected for the application collection 330, the addition feature 325 can be tagged in some way to indicate to the user that that application 310 has been selected for inclusion in the collection 330. For example, when an application 310 is selected for the application collection 330, the addition feature 325 of the selected application 310 can be tagged with a check mark and/or a change in color. Of course, other suitable techniques for tagging a selected application 310 are contemplated by this description. In fact, the term “tagging” or “tag” is defined as marking, hi-lighting or otherwise designating an element in a form that is recognizable by a human or machine.

Following selection, the tagged applications 310 can be grouped together to form the application collection 330. In one arrangement, the application collection 330 can be staged in an application collection holding area 335 that can be separate from an area 340 that provides the applications 310 for potential selection into the application collection 330. This separation can enable the user to easily distinguish between applications 310 that have been selected into the application collection 330 from those in the area 340 that have not been so chosen. An “application collection holding area” is defined as a user interface element that presents grouped applications together that have been selected for inclusion in an application collection in which the presentation occurs prior to publication of the application collection. Of course, the description herein is not so limited, as selected applications 310 could simply be tagged without being grouped in a separate area or without even being separately grouped at all.

In one arrangement, removal buttons 345 may also be provided to enable a user to remove a selected application 310 from an application collection 330. Once activated, the application 310 selected for removal can be stripped from the application collection 330 and placed back in the general area 340. Moreover, a total fee for the application collection 330 can be displayed, and the following features may also be provided: a cancel button 350, a save button 355 and a finalize button 360. The cancel button 350 can remove all the applications 310 from the application collection 330, while the save button 355 can allow a user to save a collection 330 until it is finalized. The finalize button 360 can be selected when a user has determined that the application collection 330 is complete and is ready to be published, additional details for which will be presented below. A naming designation area 365 may also be provided to enable a user to name the application collection 330, which may or may not be related to the defined category.

As mentioned earlier, a total fee for the application collection 330 can be displayed, such as in the application collection holding area 335. In one embodiment, this total fee can be the cumulative amount of all the fees for all the applications 310 that make up the grouped application collection 330. In another embodiment, the processing unit 110 can calculate a reduced cumulative amount for the total fee as part of a discount for the application collection 330 to be published. This reduced amount can be adjusted based on the number of applications 310 that are selected for inclusion in the application collection 330, which can encourage a user to select a greater number of applications 310.

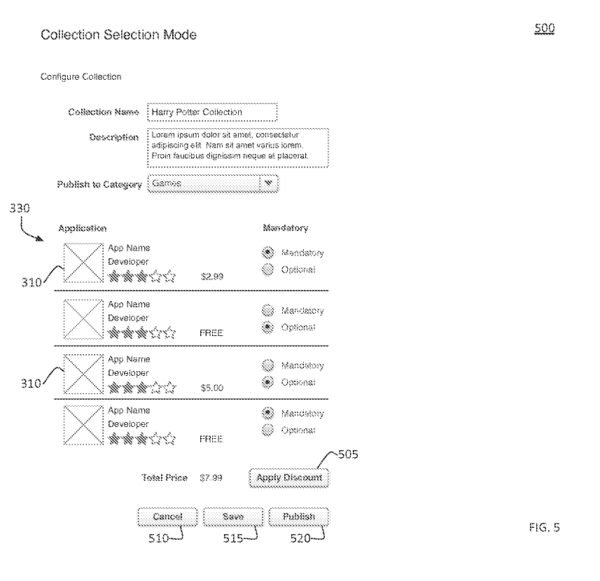

Once a user has determined that the application collection 330 is ready to be finalized, the user can select the finalize button 360. The user may then be directed to an options interface 500, an example of which is shown in FIG. 5. Here, the user can enter a description for the finalized application collection 330. The user may also select a category in which to publish the application collection 330. In one arrangement, the user may designate at least some of the applications 310 in the application collection 330 as optional or mandatory for inclusion in the application collection 330 to be published. In particular, if an application 310 is designated as an optional application 310, a consumer who wishes to purchase the application collection 330 may have permission to strike that particular application 310 from the application collection 330 for download. Conversely, if an application 310 is designated as mandatory, the application 310 must or at least should be included in the application collection 330 when purchased.

There are numerous factors that may go into deciding whether an application 310 should be listed as mandatory or optional. For example, applications 310 that cost above a certain threshold or are at least not free may be listed as optional. As another example, an employer may decide to provide application collections 330 for its employees, and the employer may wish to list as mandatory some applications 310 that are important to its business. One skilled in the art will appreciate that these examples are not intended to be limiting, as other considerations may be involved in determining how an application 310 should be designated.

The options interface 500 can also include an apply discount button 505, which can cause the discount described above to be applied to the total cost of the application collection 330. The interface 500 can also have a cancel button 510 for canceling the data entered on the interface 500, a save button 515 for saving such data and a publish button 520, which can cause the application collection 330 to be published.

Once the publish button 520 is activated, the processing unit 110 can cause the application collection 330 to be published in an application store as an offering based on the defined category. The phrase “publishing the application in an application store” is defined as presenting or causing to be presented an application collection in an application store or other online platform such that a user or machine is capable of downloading the application collection onto a computing device. As another alternative, the application collection 330 can be saved and stored for publication at a later date. For example, once the application collection 330 is finalized, the user may decide to save the collection 330 instead of directly publishing the collection 330. In this manner, the user may be granted additional opportunities to modify or edit the application collection 330 prior to publication, such as by adding or deleting applications 310 from the collection 330.

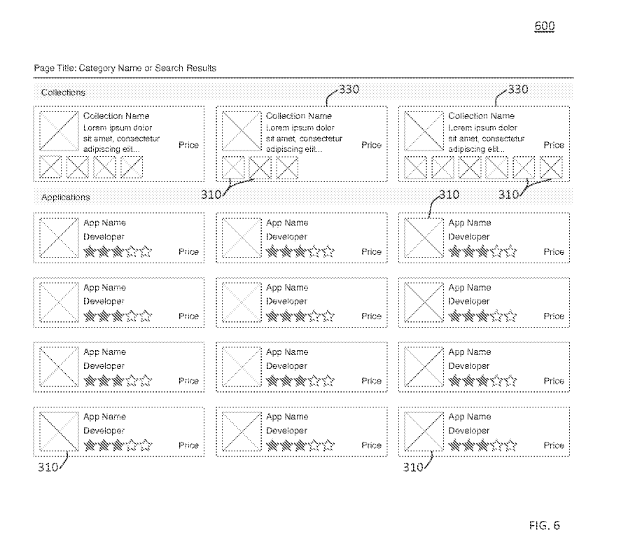

Referring to FIG. 6, an example of a presentation 600 of an application store that can be hosted by one or more of the application store servers 135 is illustrated. Here, applications 310 and application collections 330 may be provided to a consumer for installation on a computing device. In one embodiment, the name and a description of the application collection 330 can be displayed, along with the overall cost associated with its purchase, which may or may not reflect a discounted price. In addition, the applications 310 that are contained in the application collection 330 can be presented. A consumer can search for a particular application collection 330 through a key word search or via browsing one or more menus.

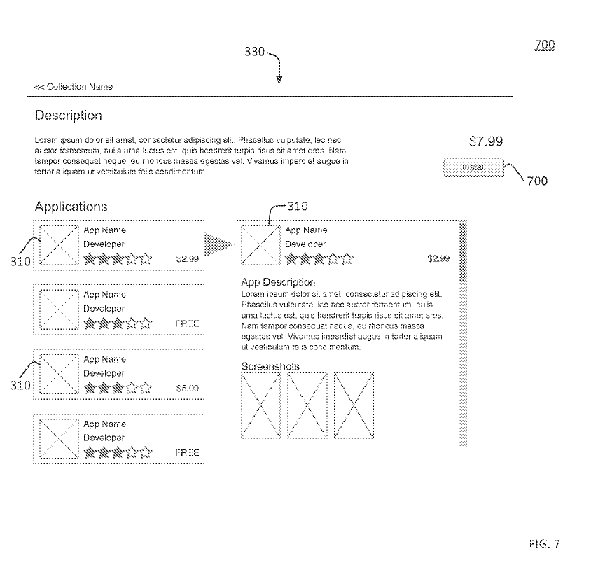

By selecting one of the application collections 330 of FIG. 6, a consumer can learn more about the specifics of the collection 330. Referring to FIG. 7, an example of a detailed illustration of a selected application collection 330 is shown. In this example, a description of the application collection 330, which can provide information related to the theme of the collection 330, can be displayed, along with the cost associated with its installation. Moreover, each of the applications 310 that are part of the collection 330 can be presented, and by selecting an application 310 here, a description and screenshots of the application 310 in operation 310 can be shown. An install button 700 can be provided to enable the consumer to install the application collection 330 on the relevant computing device.

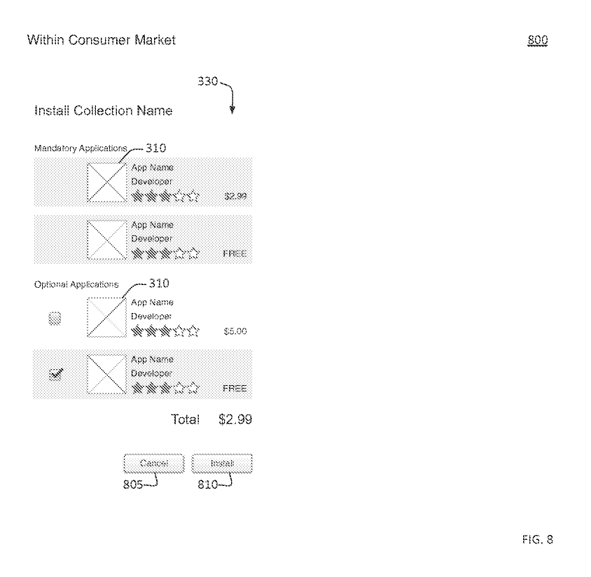

Referring to FIG. 8, an interface 800 may be presented to the consumer that can give the consumer the option of removing from the application collection 330 those applications 310 that have been designated as optional. In this example, the consumer can simply click on the optional applications 310 that the consumer wants to keep as part of the collection 330. The interface 800 may also include a cancel button 805 to enable the consumer to cancel the installation and an install button 810 to continue with the installation. As part of the installation, the consumer may be kept apprised as to the status of the download/installation of the application collection 330 as a whole, each of the applications 310 of the collection 330 on an individual basis or a combination of the two.

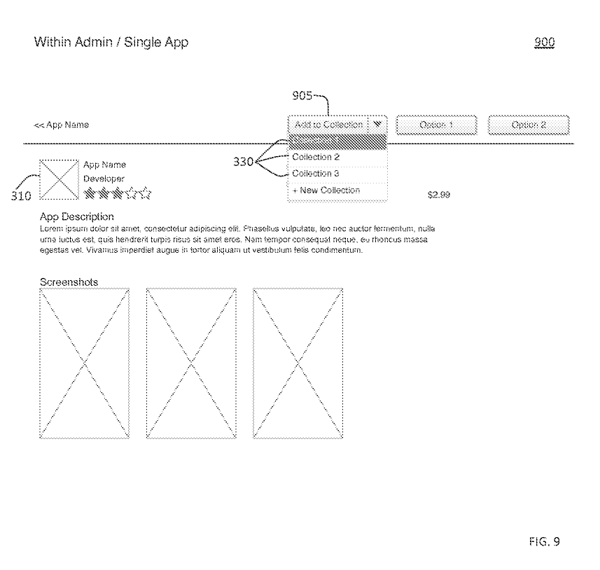

It must be noted that applications 310 may be added or removed from an application collection 330 at any time, including after the collection 330 has been finalized or even after the collection 330 has been published. For example, referring to FIG. 9, an interface 900 may be presented to the user that enables the user to add an individual application 310 to an application collection 330. In particular, the user may discover an application 310 that is a suitable candidate for addition to an existing collection 330. As part of the interface 900 that is presented for describing the individual application 310, a modification button 905 can be provided. From the modification button 905, a user can select one or more application collections 330 for receiving the application 310. If the application collection 330 is not listed, the user may simply add the application collection 330 via the modification button 905. In another arrangement, the modification button 905 can be configured to remove one or more applications 310 from an application collection 330. Moreover, multiple applications 330 can be simultaneously added to or removed from an application collection 330, as such a process is not limited to individual applications 310. This process of adding or removing applications 310 is also applicable to application collections 330 that have been finalized but not yet published, as previously presented above.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

While various embodiments have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the claims and their equivalents should not be limited by any of the above-described exemplary embodiments.

What is claimed is:

1. A method for creating an application collection, comprising:
providing a plurality of applications for potential selection as part of an application collection based on a defined category;
receiving selections that designate one or more of the provided applications for inclusion in the application collection;
tagging the applications based on the received selections;
grouping the tagged applications together to form the application collection; and
publishing the application collection in an application store as an offering based on the defined category.

2. The method according to claim 1, further comprising receiving additional selections that designate at least some of the applications selected for inclusion in the defined category as mandatory or optional for inclusion in the application collection to be published.

3. The method according to claim 1, further comprising enabling an individual application to be added to the published application collection.

4. The method according to claim 1, further comprising:
determining fees that are associated with applications that are part of the grouped application collection; and
providing a reduced cumulative amount for the determined fees as part of a discount for the application collection to be published.

5. The method according to claim 1, wherein the defined category is a movie theme, a restaurant theme, a hotel theme, a sports team theme, a geographical location theme, a manufacturer or retailer theme, an activity theme, an occupation theme, a historical theme, a fashion theme, an academic subject theme or a music theme.

6. The method according to claim 1, wherein grouping the tagged applications comprises staging the tagged applications in an application collection holding area that is separate from the area that provides the plurality of applications for potential selection as part of the application collection.

7. A method for creating an application collection, comprising:
presenting a plurality of applications for potential selection as part of an application collection based on a defined category, wherein the applications are presented based on one or more search terms or a selection of a predefined macro organizer;
receiving selections that designate one or more of the presented applications for inclusion in the application collection;
tagging the applications based on the received selections;
staging the tagged applications in an application collection holding area to form the application collection; and
publishing the application collection in an application store as an offering based on the defined category.

8. A system for creating an application collection, comprising:
a display unit, wherein the display unit is configured to display a plurality of applications for potential selection as part of an application collection based on a defined category; and
a processing unit that is communicatively coupled to the display unit, wherein the processing unit is configured to:
receive selections that designate one or more of the provided applications for inclusion in the application collection;
tag the applications based on the received selections;
group the tagged applications together to form the application collection; and
direct the publication of the application collection in an application store as an offering based on the defined category.

9. The system according to claim 8, wherein the processing unit is further configured to receive additional selections that designate at least some of the applications selected for inclusion in the application collection as mandatory or optional for inclusion in the application collection to be published.

10. The system according to claim 8, wherein the processing unit is further configured to enable an individual application to be added to the published application collection.

11. The system according to claim 8, wherein the processing unit is further configured to:
determine fees that are associated with applications that are part of the grouped application collection; and
determine a reduced cumulative amount for the determined fees as part of a discount for the application collection to be published.

12. The system according to claim 8, wherein the processing unit groups the tagged applications by staging the tagged applications in an application collection holding area.
